(19) United States
(12) Patent Application Publication
(10) Pub. No.: US 2010/0009174 A1
(43) Pub. Date: Jan. 14, 2010

(54) Heat Dissipation For Low Profile Devices

(76) Inventor: Bradley E. Reis, Westlake, OH (US)

Correspondence Address: GrafTech International Holdings, Inc., 12900 Snow Road, Parma, OH, 44130, US

(21) Appl. No.: 12/170,772

(22) Filed: Jul. 10, 2008

(51) Int. Cl. B32B 3/30; B32B 5/02; F28F 13/00

(52) U.S. Cl. 428/332; 428/408; 136/246; 165/80.2

(57) ABSTRACT

A heat spreader for an electronic device including a first layer formed of at least one sheet of compressed particles of exfoliated graphite having two major surfaces; and a second layer formed of a metal foil having two major surfaces, a first major surface of the metal foil having surface structures thereon, wherein a first major surface of the graphite layer and a second major surface of the metal foil layer are in thermal connection with each other, the surface structures on the first major surface of the metal foil which create airflow turbulence, increase heat dissipation surface area, or both.

### TECHNICAL FIELD

The present invention relates to improving heat dissipation in low profile devices, such as flat panel displays, laptop computers, cell phones, personal digital assistants and the like. More particularly, the present invention relates to an apparatus and method for facilitating and improving heat dissipation from low profile devices, especially thin handheld devices, where the space within the case of the device is limited. The term “low profile device” as used herein means an electronic device having a ratio of the surface area of a major surface (i.e length times width of one of the major surfaces, measured in square inches) to average thickness (in inches) of at least about 10:1 inches, more commonly at least about 15:1 inches (of course, the artisan will recognize this calculation is done based on a device such as a cell phone or laptop computer, etc. in the open and in-use position, and a flat panel display not including the stand, etc.).

### BACKGROUND OF THE INVENTION

It has become a goal to make electronic devices like flat panel displays, and portable devices such as laptop computers, cell phones, personal digital assistants, and the like, smaller and lighter, while maintaining functionality. This has culminated to date in devices such as the Sony OLED (organic light emitting diode) 11″ flat panel television, which is only 3 mm thick at some locations, the MacBook Air laptop computer from Apple Inc., which is only 1.94 cm thick (in the closed position), the iPhone 3G personal digital assistant, also from Apple Inc., which is only 12.3 mm thick, and the Motorazr V3 cell phone from Motorola, Inc. which is only 13.9 mm thick (in the closed position). In addition, photovoltaic solar panels for generating electricity from solar energy, are also being designed to be as thin as possible.

One significant impediment to making yet smaller and thinner devices is heat management. While many device components can be effectively minimized, the power requirements needed to provide the functionality sought by consumers, where even basic cell phones are expected to include features such as games, digital cameras, internet access, etc., are growing. When these power requirements are combined with the lack of space within the device, heat management is often a limiting factor.

In other words, without effective heat management, device components can rapidly overheat, which can lead to intermittent or even catastrophic failure. In order to produce a robust and long-lived device, it is necessary to dissipate heat from those device components which generate heat, such as chipsets and the like, while not significantly increasing space requirements.

In the broader field of larger electronic devices, various heat management technologies have been developed. Of course, “desktop” computers, larger television sets and some larger laptop computers incorporate fans to move air across the heat source to facilitate heat dissipation. In addition, heat spreaders, such as sheets of compressed particles of exfoliated natural graphite flakes have been used to great advantage in heat spreading applications even in smaller devices, due to their anisotropy (directional heat spreading).

For instance, Reis et al. describe a heat spreader formed of compressed particles of exfoliated graphite for use with a flash LED light source for the camera of a handheld device such as a cell phone, in U.S. Pat. No. 7,365,988. The graphite-based heat spreader provides reduced operating temperatures at increased power levels, providing improved lighting and operating life of the electronic components.

In U.S. Pat. No. 7,292,441, Smalc et al. disclose a thermal solution for a portable electronic device, such as a laptop computer, where the thermal solution is positioned between a heat source and another component or the outer case of the device, where the thermal solution facilitates heat dissipation from the heat source while shielding the second component or outer case from the heat generated by the heat source. The Smalc et al. thermal solution comprises sheets of compressed particles of exfoliated graphite.

Also, in U.S. Pat. No. 7,385,819 Shives et al., and in U.S. Pat. No. 7,306,847 Capp et al., disclose the use of sheets of compressed particles of exfoliated graphite to improve heat dissipation in display devices, such as plasma display panels, liquid crystal display devices, and other types of display devices in use today.

While traditional heat spreading materials like copper or aluminum have also been suggested, these materials add significant weight to the device, which is undesirable. Moreover, since metals like copper and aluminum are isotropic, heat tends to flow through the thickness of the heat spreader readily, and resulting hot-spots can occur on the heat spreader, in the location directly opposite the heat source. These hot spots can negatively affect touch temperatures of the case of the device, or even adjacent temperature-sensitive components.

Accordingly, the preferred material for use as a heat spreader for an electronic device is formed of one or more sheets of compressed particles of exfoliated graphite flakes.

Natural graphite, on a microscopic scale, is made up of layer planes of hexagonal arrays or networks of carbon atoms. These layer planes of hexagonally arranged carbon atoms are substantially flat and are oriented or ordered so as to be substantially parallel and equidistant to one another. The substantially-flat, parallel, equidistant sheets or layers of carbon atoms, usually referred to as graphene layers or basal planes, are linked or bonded together and groups thereof are arranged in crystallites. Highly-ordered graphite materials consist of crystallites of considerable size, the crystallites being highly aligned or oriented with respect to each other and having well ordered carbon layers. In other words, highly ordered graphites have a high degree of preferred crystallite orientation. It should be noted that graphites, by definition, possess anisotropic structures and thus exhibit or possess many characteristics that are highly directional, e.g., thermal and electrical conductivity and fluid diffusion.

Briefly, natural graphite flakes may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing sheets of compressed particles of exfoliated graphite possess a very high degree of orientation.

As noted above, the bonding forces holding the parallel layers of carbon atoms together are only weak van der Waals forces. Natural graphites can be chemically treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Natural graphite flake which has been chemically or thermally expanded and more particularly expanded so as to have a final thickness or “c” direction dimension which is as much as about 80 or more times the original “c” direction dimension, can be formed without the use of a binder into cohesive or integrated sheets of expanded graphite, e.g. webs, papers, strips, foils, tapes, or the like. The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy to thermal and electrical conductivity due to orientation of the expanded graphite particles substantially parallel to the opposed faces of the sheet resulting from compression, e.g. roll processing. Sheet material thus produced has excellent flexibility, good strength and a very high degree of orientation.

Briefly, the process of producing flexible anisotropic expanded natural graphite sheet material, e.g. web, paper, strip, tape, foil, or the like, comprises compressing or compacting under a predetermined load and, if desired, in the absence of a binder, exfoliated (also referred to as expanded) graphite particles which have a “c” direction dimension which is as much as about 80 or more times that of the original particles so as to form a substantially flat, flexible, integrated cohesive graphite sheet. The expanded graphite particles that generally are worm-like or vermiform in appearance will, once compressed, maintain the compression set and alignment with the opposed major surfaces of the sheet. Properties of the sheets may be altered by coatings and/or the addition of binders or additives prior to the compression step. See U.S. Pat. No. 3,404,061 to Shane, et al. The density and thickness of the sheet material can be varied by controlling the degree of compression. Higher in-plane strength and thermal conductivity are generally found in more dense sheets. Typically, the density of the sheet material will be within the range of from about 1.1 grams per cubic centimeter (g/cc) to about 1.8 g/cc or even as high as 2.0 g/cc or higher.

Natural graphite sheet material made as described above typically exhibits an appreciable degree of anisotropy due to the alignment of graphite particles parallel to the major opposed, parallel surfaces of the sheet, with the degree of anisotropy increasing upon roll pressing of the sheet material to increased density. In roll-pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal properties of the sheet are very different, by orders of magnitude typically, for the “c” and “a” directions.

However, even given the superior heat dissipation achieved by the graphite sheets described above, further heat dissipation improvements are needed if yet smaller and thinner devices are to be developed, having improved and additional functionality. What is desired, therefore, is a mechanism for heat management and/or dissipation in a low profile electronic device such as a flat panel display, laptop computer, cell phone, personal digital assistant or the like, which leverages the unique heat spreading capabilities of sheets of compressed particles of expanded graphite flakes to provide improved heat dissipation.

### SUMMARY OF THE INVENTION

In one aspect of the present invention a heat spreader is presented, the heat spreader including a first layer which comprises at least one sheet of compressed particles of exfoliated graphite having two major surfaces; and a second layer which comprises a metal foil having two major surfaces, a first major surface of the metal foil having surface structures thereon, wherein at least about 25% of the surface area of a first major surface of the graphite layer is in thermal connection with a second major surface of the metal foil layer, further wherein the surface structures on the first major surface of the metal foil layer have a height no greater than about 10 times the thickness of the first layer of the heat spreader, and which increase airflow turbulence, increased heat dissipation surface area, or both.

The first layer of the heat spreader, i.e., the graphite layer, advantageously has a thickness of from about 0.05 mm to about 2.0 mm, and an in-plane thermal conductivity of at least about 150 W/m-K. In one embodiment, the second layer of the heat spreader, i.e., the metal foil layer, has a thickness of from about 0.025 mm to about 1.0 mm, and the metal foil is formed of aluminum, copper, steel or combinations thereof.

In another embodiment, the invention includes an electronic device, such as a low profile electronic device, which includes the heat spreader as described hereinabove and a mechanism which directs air across the surface structures of the second layer of the heat spreader.

Preferably, the mechanism which directs air across the surface structures of the second layer is a fan, most preferably a fan which includes a diffuser which directs the flow of air across the heat spreader so as to improve heat dissipation as compared to a fan without the diffuser.

In still another embodiment, a second major surface of the first layer of the heat spreader is in thermal connection with a surface of a heat source. Indeed, advantageously, the surface area of the second major surface of the first layer is greater than the surface area of that part of the heat source with which the second major surface of the first layer is in thermal connection.

Other and further embodiments, features, and advantages of the present invention will be readily apparent to those skilled in the art, upon a reading of the following disclosure when taken in conjunction with the accompanying drawings.

### BRIEF DESCRIPTION OF THE DRAWINGS

FIG. 1 is a side plan cross-sectional view of one embodiment of the heat spreader of the present invention.

FIG. 2 is a partially broken away top perspective view of the heat spreader of FIG. 1, showing one embodiment of the surface structures on the second layer.

FIG. 3 is a partially broken away top perspective view of another embodiment of the heat spreader of the present invention, showing another embodiment of the surface structures on the second layer.

FIG. 4 is a partially broken away top perspective view of yet another embodiment of the heat spreader of the present invention, showing another embodiment of the surface structures on the second layer.

FIG. 5 is a top perspective view of still another embodiment of the heat spreader of the present invention, showing another embodiment of the surface structures on the second layer.

FIG. 6 is a side plan cross-sectional view of another embodiment of the heat spreader of the present invention, showing still another embodiment of the surface structures on the second layer.

FIG. 7 is a top perspective view of yet another embodiment of the heat spreader of the present invention, showing still another embodiment of the surface structures on the second layer.

FIG. 8 is a top perspective view of another embodiment of the heat spreader of the present invention, showing still another embodiment of the surface structures on the second layer.

FIG. 9 is a top plan view of one embodiment of the heat spreader of the present invention, in combination with a fan and diffuser.

FIG. 10 is a partial side plan view of a cell phone, having an embodiment of the heat spreader of the present invention, in combination with a fan and diffuser.

FIG. 11 is a partial side plan view of an FB-DIMM memory module, having an embodiment of the heat spreader of the present invention mounted thereto.

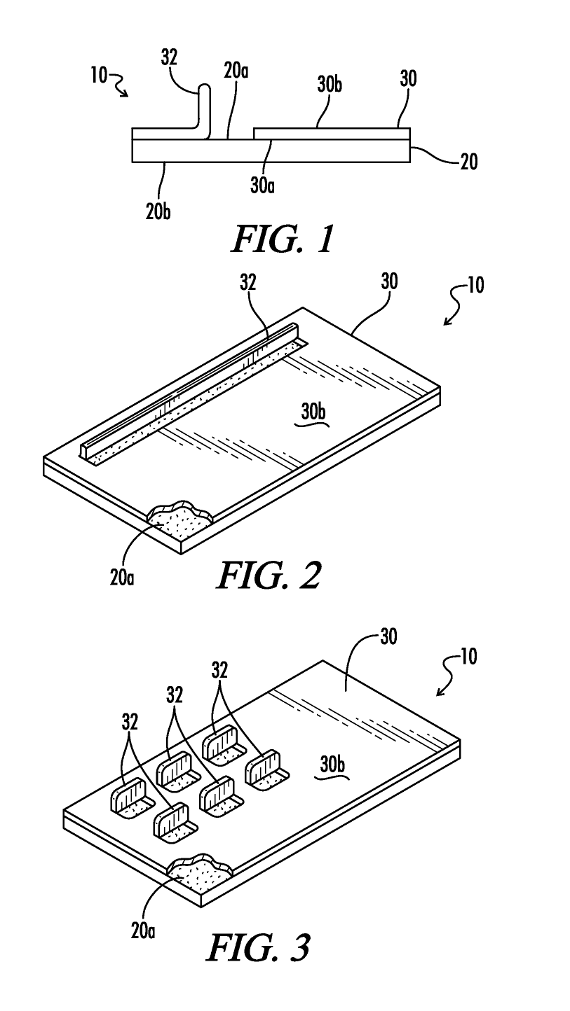

### DETAILED DESCRIPTION OF THE PREFERRED EMBODIMENTS

Referring now to the drawings (in which not all elements are shown with reference numbers in each drawing, for simplicity sake), the present invention is based upon the finding that the thermal operation of a low profile electronic device, such as a flat panel display, a portable electronic device such as a laptop computer, cell phone, personal digital assistant or the like, or a photovoltaic solar panel, can be substantially improved by the addition of a composite heat spreader, designated as reference numeral 10, formed of at least one sheet of compressed particles of exfoliated graphite as a first layer 20 and a metal foil having surface structures 32 thereon as a second layer 30, where the surface structures 32 provide increased surface area for heat dissipation and/or increased airflow turbulence. The electronic device, designated as reference numeral 100, can operate at substantially increased power levels thus providing for improved functionality, while still operating at significantly reduced operating temperatures.

Before describing the manner in which the invention improves current materials, a brief description of natural graphite and its formation into flexible sheets, which will be used as the first layer 20 of heat spreader 10 for forming the products of the invention, is in order.

Natural graphite is a crystalline form of carbon comprising atoms covalently bonded in flat layered planes with weaker bonds between the planes. By treating natural graphite flake with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes.

Natural graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources.

The natural graphite starting materials used in the present invention may contain non-graphite components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has a purity of at least about eighty weight percent. More preferably, the graphite employed for the present invention will have a purity of at least about 94%. In the most preferred embodiment, the graphite employed will have a purity of at least about 98%.

A common method for manufacturing natural graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). In one preferred embodiment, the intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 350 pph and more typically about 40 to about 160 pph. After the flakes are intercalated, any excess solution is drained from the flakes and the flakes are water-washed. Alternatively, the quantity of the intercalation solution may be limited to between about 10 and about 40 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1,10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will advantageously be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 25° to 125° C. to promote reaction of the reducing agent and intercalant coating. The heating period is up to about 20 hours, with shorter heating periods, e.g., at least about 10 minutes, for higher temperatures in the above-noted range. Times of one half hour or less, e.g., on the order of 10 to 25 minutes, can be employed at the higher temperatures.

As noted, the thusly treated particles of graphite can be referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compressed together into flexible sheets (referred to herein as sheets of compressed particles of exfoliated graphite) that, unlike the original graphite flakes, can be formed and cut into various shapes.

For use in the present invention, graphite sheet is coherent, with good handling strength, and is suitably compressed, e.g. by roll pressing, to a thickness of about 0.05 mm to 2.0 mm and a typical density of about 1.1 to 1.8 g/cc or even as high as 2.0 g/cc or higher. From about 1.5-30% by weight of ceramic additives can be blended with the intercalated graphite flakes as described in U.S. Pat. No. 5,902,762 (which is incorporated herein by reference) to provide enhanced resin impregnation in the final flexible graphite product, if resin impregnation is desired.

The above described methods for intercalating and exfoliating graphite flake, and forming sheets of compressed particles of exfoliated graphite flake, may beneficially be augmented by a pretreatment of the graphite flake at graphitization temperatures, i.e. temperatures in the range of about 3000° C. and above and by the inclusion in the intercalant of a lubricious additive, as described in International Patent Application No. PCT/US02/39749, the disclosure of which is incorporated herein by reference.

This pretreatment, or annealing, of the graphite flake may result in significantly increased expansion (i.e., increase in expansion volume of up to 300% or greater) when the flake is subsequently subjected to intercalation and exfoliation. Indeed, desirably, the increase in expansion is at least about 50%, as compared to similar processing without the annealing step. The temperatures employed for the annealing step should not be significantly below 3000° C., because temperatures even 100° C. lower result in substantially reduced expansion.

The annealing of the graphite flake is performed for a period of time sufficient to result in a flake having an enhanced degree of expansion upon intercalation and subsequent exfoliation. Typically the time required will be 1 hour or more, preferably 1 to 3 hours and will most advantageously proceed in an inert environment. For maximum beneficial results, the annealed graphite flake will also be subjected to other processes known in the art to enhance the degree expansion—namely intercalation in the presence of an organic reducing agent, an intercalation aid such as an organic acid, and a surfactant wash following intercalation. Moreover, for maximum beneficial results, the intercalation step may be repeated.

The annealing step may be performed in an induction furnace or other such apparatus as is known and appreciated in the art of graphitization; for the temperatures here employed, which are in the range of 3000° C., are at the high end of the range encountered in graphitization processes.

Because it has been observed that the worms produced using graphite subjected to pre-intercalation annealing can sometimes “clump” together, which can negatively impact area weight uniformity, an additive that assists in the formation of “free flowing” worms is highly desirable. The addition of a lubricious additive to the intercalation solution facilitates the more uniform distribution of the worms across the bed of a compression apparatus (such as the bed of a calender station) conventionally used for compressing (or “calendering”) graphite worms into flexible graphite sheet. The resulting sheet therefore has higher area weight uniformity and greater tensile strength. The lubricious additive is preferably a long chain hydrocarbon, more preferably a hydrocarbon having at least about 10 carbons. Other organic compounds having long chain hydrocarbon groups, even if other functional groups are present, can also be employed.

More preferably, the lubricious additive is an oil, with a mineral oil being most preferred, especially considering the fact that mineral oils are less prone to rancidity and odors, which can be an important consideration for long term storage. It will be noted that certain of the expansion aids detailed above also meet the definition of a lubricious additive. When these materials are used as the expansion aid, it may not be necessary to include a separate lubricious additive in the intercalant.

The lubricious additive is present in the intercalant in an amount of at least about 1.4 pph, more preferably at least about 1.8 pph. Although the upper limit of the inclusion of lubricous additive is not as critical as the lower limit, there does not appear to be any significant additional advantage to including the lubricious additive at a level of greater than about 4 pph.

The natural graphite sheets of the present invention may, if desired, utilize particles of reground graphite sheets rather than freshly expanded worms, as discussed in U.S. Pat. No. 6,673,289 to Reynolds et al., the disclosure of which is incorporated herein by reference. The sheets may be newly formed sheet material, recycled sheet material, scrap sheet material, or any other suitable source.

Also the processes of the present invention may use a blend of virgin materials and recycled materials.

One type of apparatus for continuously forming compressed natural graphite materials is shown in U.S. Pat. No. 6,706,400 to Mercuri et al., the disclosure of which is incorporated herein by reference.

In one embodiment, when the sheets of compressed particles of exfoliated graphite are resin-impregnated, following the compression step (such as by calendering), the impregnated materials are placed in a press, where the resin is cured at an elevated temperature and pressure. In addition, the natural graphite sheets can be employed in the form of a laminate, which can be prepared by stacking together individual graphite sheets in the press.

The temperature employed in the press should be sufficient to ensure that the graphite structure is densified at the curing pressure, while the thermal properties of the structure are not adversely impacted. Generally, this will require a temperature of at least about 90° C., and generally up to about 200° C. Most preferably, cure is at a temperature of from about 150° C. to 200° C. The pressure employed for curing will be somewhat a function of the temperature utilized, but will be sufficient to ensure that the graphite structure is densified without adversely impacting the thermal properties of the structure. Generally, for convenience of manufacture, the minimum required pressure to densify the structure to the required degree will be utilized. Such a pressure will generally be at least about 7 megapascals (Mpa, equivalent to about 1000 pounds per square inch), and need not be more than about 35 Mpa (equivalent to about 5000 psi), and is more commonly from about 7 to about 21 Mpa (1000 to 3000 psi). The curing time may vary depending on the resin system and the temperature and pressure employed, but generally will range from about 0.5 hours to 2 hours. After curing is complete, the materials are seen to have a density of at least about 1.8 g/cc and commonly from about 1.8 g/cc to 2.0 g/cc.

Advantageously, when the natural graphite sheets are themselves presented as a laminate, the resin present in the impregnated sheets can act as the adhesive for the laminate. According to another embodiment of the invention, however, the calendered, impregnated, natural graphite sheets are coated with an adhesive before they are stacked and cured. Suitable adhesives include epoxy-, acrylic- and phenolic-based resins. Phenolic resins found especially useful in the practice of the present invention include phenolic-based resin systems including resole and novolak phenolics.

Although the formation of sheets through calendering or molding is the most common method of formation of the graphite materials useful in the practice of the present invention, other forming methods can also be employed.

Referring now to the figures, and as noted, a heat spreader in accordance with the invention is denoted by the reference numeral 10. The heat spreader 10 comprises a first layer which comprises at least one sheet of compressed particles of exfoliated graphite, denoted 20 and a second layer which comprises a metal foil, denoted 30. For use in the heat spreader 10 in accordance with the present invention, the graphite sheets have an in-plane thermal conductivity which can in some circumstances rival or exceed that of aluminum or even copper, at a fraction of their weight. More specifically, the sheets of compressed particles of exfoliated graphite exhibit in-plane thermal conductivities of at least about 150 W/m-K, more preferably 220 W/m-K, and most preferably at least about 390 W/m-K, with through-plane thermal conductivities of less than about 15 W/m-K, more preferably less than about 10 W/m-K.

In addition, as discussed, the sheet or sheets or compressed particles of exfoliated graphite used as the first layer 20 of the inventive heat spreader advantageously has a density which can vary between about 0.05 g/cc and about 2.0 g/cc; more preferably, the density of the sheet is between about 1.4 g/cc and about 1.8 g/cc. The thickness of the graphite sheet(s) should be between about 0.05 mm and about 2.0 mm. In the preferred embodiment, the one or more sheets of compressed particles of exfoliated graphite are between about 0.25 mm and about 1.0 mm in thickness.

The first layer 20 of the inventive heat spreader 10, i.e., the layer which comprises at least one sheet of compressed particles of exfoliated graphite, has two major surfaces, denoted 20a and 20b. The second layer 30 comprises a metal foil (and thus also has two major surfaces, denoted 30a and 30b); preferably the metal foil is one formed of aluminum, copper, steel or combinations thereof.

Advantageously, one of the major surfaces 20a of the first layer 20 is in thermal connection with one of the major surfaces 30a of the second layer 30. By “thermal connection” is meant that effective thermal transfer occurs between the articles which are in thermal connection, in this case, between the layers 20 and 30; that is, a measurable amount of the heat applied to one of the articles (i.e. layers) is transferred to the other article (i.e. layer). Indeed, in the preferred embodiment, at least 30% of the thermal energy applied to the first layer 20 is transferred to the second layer 30.

Advantageously, at least about 25%, more preferably at least about 50%, of the surface area of one of the major surfaces 20a of the first layer 20 is adhered or attached to, or is in contact with, one of the major surfaces 30a of the second layer 30. Most commonly, first layer 20 is adhered or attached to second layer 30 by an adhesive, denoted 25 in FIG. 5, with the adhesive interposed between the first layer 20 and the second layer 30; where the adhesive is not present, the major surface 20a of the first layer is preferably in direct contact with the major surface 30a of the second layer 30.

Suitable adhesives for adhering the first layer 20 and the second layer 30 together, in order to bring them into thermal connection with each other and to form the heat spreader 10 include resins, such as silicone-, epoxy-, acrylic- and phenolic-based resins. Also, in one embodiment, the adhesive is a silicone adhesive filled with conductive particles, in order to improve inter-layer thermal conductivity. In another preferred embodiment, phenolic resins, such as resole and novolak phenolics, are employed since a relatively thin film of the phenolic resins can adhere the first layer 20 and the second layer 30 together, thus maximizing the thermal connection between the layers.

The second layer 30 can have a thickness of about 0.025 mm and about 1.0 mm. Advantageously, the thickness of the second layer 30 is between about 0.05 mm and about 0.25 mm. The metal foil is thermally isotropic, and the thermal conductivities of aluminum and copper are relatively constant.

One advantage of the use of the heat spreader 10, formed as a composite of a first layer 20 and a second layer 30, is that forming surface structures 32 on the second layer 30 which results in the second layer 30 being non-continuous (i.e., there being gaps or holes in the second layer 30), allows the first layer 20 to remain continuous, preserving the continuity of the heat spreader 10 regardless of the number and nature of surface structures 32. In addition, a heat spreader 10 which comprises a first layer 20 comprising at least one sheet of compressed particles of exfoliated graphite having a thickness between 0.05 mm and 2.0 mm and a second layer 30 which comprises a metal foil having a thickness between 0.025 mm and 1.0 mm will weigh significantly less than the equivalent heat spreader formed solely of the metal foil. Moreover, given the high in-plane thermal conductivity of the graphite sheet, and the anisotropic nature of the graphite layer 20, heat spreading, and the avoidance of hot spots, from the heat spreader 10 disclosed herein will be significantly improved over a metal-only heat spreader.

In addition, the second layer 30 has surface structures 32 thereon. More particularly, one of the major surfaces 30a of the second layer 30 is in thermal connection with the first layer 20; the second major surface 30b of the second layer has surface structures 32 thereon to improve heat dissipation, by increasing the surface area of the heat spreader 10 available for heat dissipation or by increasing the airflow turbulence about the heat dissipation surface 12 of the heat spreader 10, or both.

These surface structures 32 can take different forms, as especially illustrated in FIGS. 2-4, depending on the particular heat dissipation needs faced. In one embodiment, the surface structures 32 can comprise one or more flaps which are formed by slitting the second layer 30 and folding the flap(s) up (this likely needs to be done prior to mating of the second layer 30 to the first layer 20). These flaps can be arrayed only in discrete areas such as along the length of the heat spreader 10 (as shown in FIG. 2), or across its width (not shown), or even diagonally (also not shown), depending on the heat dissipation needs. In addition, the flaps can be arrayed along the edges of the heat spreader 10, in order to form a conduit for airflow along the heat spreader 10, as shown in FIG. 5.

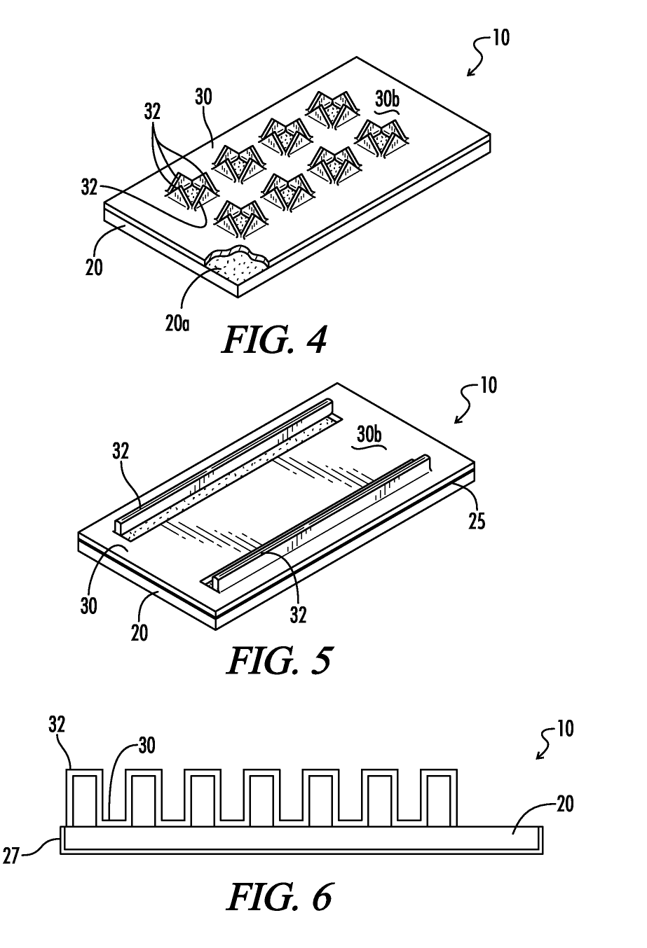

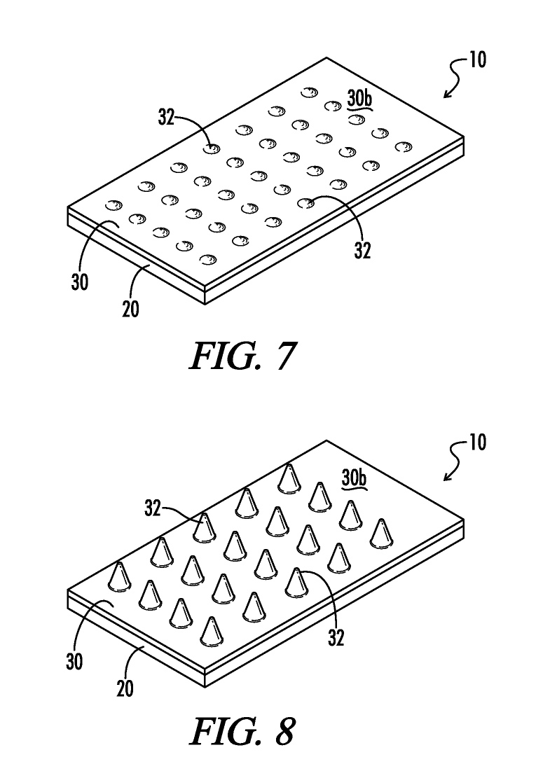

Alternatively, the surface structures 32 can comprise a plurality of fins (illustrated by reference to FIGS. 3 and 4) formed by forcing a punch or the like through the second layer 30 (again, likely prior to mating the second layer 30 to the first layer 20). These fins can be arrayed linearly (FIG. 3), or grouped about a common punch-hole (FIG. 4). In one embodiment illustrated in FIG. 4, these fins can be visualized as providing the image of a cheese grater. In still another embodiment, the second layer 30 can be formed as a so-called folded fin structure, as shown in FIG. 6, where the metal foil from which the second layer 30 is formed is folded into a corrugated pattern, with the raised areas comprising surface structures 32. Another embodiment of surface structures 32 can simply be dimples, as illustrated in FIG. 7, or raised cones, as shown in FIG. 8, in the second major surface 30b of second layer 30.

The height, number, shape, direction and grouping of the surface structures 32 will be readily determined by the skilled artisan, depending on factors such as placement of the heat source, airflow, heat dissipation needs, and the like. Advantageously, the surface structures 32 have a height that is no more than about 10 times the thickness of the first layer 20, more preferably no more than 5 times and most preferably no more than 3 times the thickness of the first layer 20. In most embodiments, the surface structures 32 are no more than about 10 mm in height, preferably between about 0.1 and 10 mm in height.

In addition to functioning themselves to increase the heat dissipation surface area and/or improved airflow turbulence of the heat spreader 10, the surface structures 32 may also expose portions of the graphite first layer 20, thus providing even more heat dissipation. Also, the surface structures 32 can also be arrayed at a location corresponding to the heat source to facilitate heat dissipation.

In a highly preferred embodiment, heat spreader 10 is positioned within a low profile electronic device 100, in order to facilitate heat dissipation from heat-generating components of device 100. As noted above, the device 100 can be a flat panel display, such as a liquid crystal display (LCD), an organic light emitting diode (OLED) display, a field emission display (FED), a surface-conduction electron-emitter display (SED), or a light emitting diode (LED) display. LCD displays may utilize LEDs, OLEDs, cold cathode fluorescent lamps (CCFL) or flat fluorescent lamps (FFL) for backlighting, for example. Other low profile devices for which the heat spreader 10 of the present invention are especially useful include portable or handheld devices such as laptop computers, cell phones or personal digital assistants and the like, and photovoltaic solar panels.

Certain components of device 100 such as chipsets, hard drives, and the like generate heat during operation. Such components will be referred to herein individually as a heat source 110. For device 100 to function as desired, it is important to dissipate the heat from heat source(s) 110 in order to prevent overheating. In addition, it is also important to keep the heat generated by heat source(s) 110 from affecting other device 100 components, such as the battery, displays, the outer case of the device and keypad, etc., which could be adversely affected by the heat generated by heat source(s) 110 or adversely affect the user of the device.

In order to do so, the second major surface 20b of first layer 20 is in thermal connection with a surface of at least one heat source 110; in another embodiment, the second major surface 20b of the first layer 20 of heat spreader 10 is in thermal connection with a surface of each of a plurality of heat sources 110 of device 100. In yet another embodiment, it is second major surface 30b of the second layer 30 which is in contact with heat source(s) 110. In each embodiment, heat from heat source(s) 110 is transferred into heat spreader 10 for dissipation. Preferably, the surface area of the second major surface 20b of the first layer 20 of the heat spreader 10 is greater than the surface area of that part of the heat source(s) 110 with which second major surface 20b of the first layer 20 of the heat spreader 10 is in thermal connection, in order to increase the effective surface area of the heat source 110 for heat dissipation.

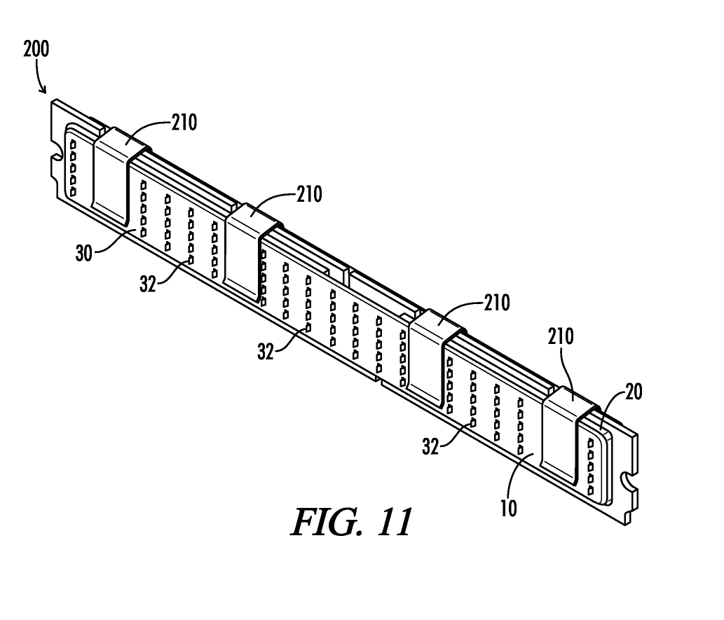

In yet another advantageous embodiment, the heat spreader 10 can be mounted to a memory module for a low profile electronic device. For instance, as shown in FIG. 11, heat spreader 10 can be mounted to an FB-DIMM module 200, such as by mounting clips 210, such that the heat spreader 10 can spread and dissipate heat generated by the FB-DIMM module 200.

In another embodiment of the present invention, the first layer 20 of the heat spreader 10 can also comprise a protective coating (denoted 27 in FIG. 6) on some or all of the surfaces of the first layer which are not in contact with the second layer 30, to forestall the possibility of graphite particles flaking from, or otherwise being separated from, the graphite first layer 20. The protective coating also advantageously effectively isolates the first layer 20, to avoid electrical interference engendered by the inclusion of an electrically conductive material (graphite) in the electronic device 100. The protective coating can comprise any suitable material sufficient to prevent the flaking of the graphite material and/or to electrically isolate the graphite, such as a thermoplastic material like polyethylene, a polyester or a polyimide, an acrylic coating, a wax and/or a varnish material. Indeed, when grounding is desired, as opposed to electrical isolation, the protective coating can comprise a metal such as aluminum.

In a preferred embodiment, and referring now to FIG. 9, device 100 can also include a mechanism which directs air across the heat spreader 10, most particularly, across the surface 30b of the second layer 30 on which surface structures 32 are located, in order to provide for improved heat dissipation. The mechanism can be any one of a number of devices, such as a fan, a blower, a piezofan, a diaphragm such as SynJet from Nuventix or the like. Most commonly, the mechanism which directs air across the heat spreader 10 comprises a fan 40.

Preferably, fan 40 is a so-called “low profile” or “miniature” fan, which is capable of use in the small spaces available in a portable electronic device 100, such as a laptop computer, cell phone, personal digital assistant and the like. While there are different definitions for what constitutes a low profile or miniature fan, for the purposes of this invention, fan 40 has a footprint, that is, the length and width surface area, of no more than about 450 mm², more preferably no more than about 300 mm², and a height (or profile) of no more than about 22 mm, more preferably no more than about 15 mm. One mechanism useful as fan 40 is the Micronel U16LM-9, which has a footprint of 100 mm² and a profile of 5 mm. This fan is rated by the manufacturer for a nominal speed of 6000 rpm. In a larger device, fan 40 will be correspondingly larger in footprint and profile.

The use of the fan 40 creates airflow about the heat spreader 10, and especially along the major surface 30b of the second layer 30 of the heat spreader 10, and thereby facilitates dissipation. When combined with the surface structures 32, which increase the surface area for dissipation of the heat spreader 10, and can increase airflow turbulence, the use of the fan 40 can have significant advantages in dissipating heat from the heat source(s) 110 of the device 100, when used with the heat spreader 10.

Moreover, it is highly desirable that the airflow exiting the fan 40 be directed onto the heat spreader 10 in the manner designed to most effectively dissipate the heat from the heat source(s) 110 of device 100. While the most effective manner of directing airflow is within the skill of the artisan and can be easily determined, depending on the spatial dimensions of the electronic device 100 and the arrangement of the surface structures 32 on the second layer 30b of the heat spreader 10, in the most preferred embodiments the airflow from the fan 40 will be directed so as to be parallel to the length of the heat spreader 10; most preferred where the surface structures 32 are arrayed in a straight line(s), the airflow from the fan 40 should be directed to the heat spreader 10 in a direction parallel to the surface structures 32.

In order to direct the airflow from the fan 40 in the desired manner, a diffuser, sometimes referred to as a duct, denoted 50, is connected between the fan 40 and the heat spreader 10, as shown in FIG. 9. The diffuser 50 matches the exit angle of airflow from the fan 40 with the arrangement of the heat spreader 10, especially the surface structures 32 on the heat spreader 10. By “straightening” the airflow from the fan 40 as it encounters the heat spreader 10, the airflow can be used as effectively as possible in dissipating heat form the device 100. In fact, it has been found that the use of a diffuser 50 can permit equivalent heat dissipation while running the fan 40 at a lower speed (and, thus saving power and battery life), or achieve improved thermal dissipation compared to the fan 40 running at the same speed but without the diffuser 50, or both.

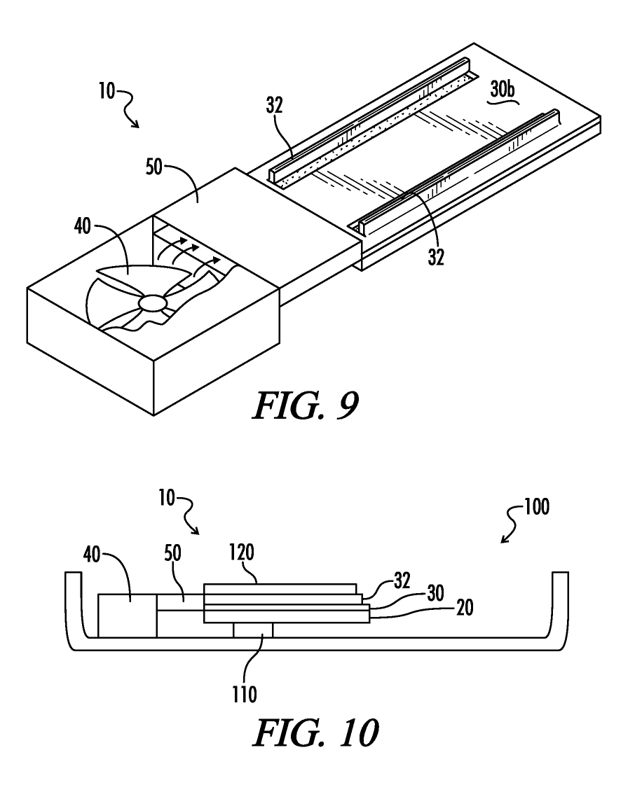

Referring now to the embodiment shown in FIG. 10, the heat spreader 10, along with the fan 40 and the diffuser 50, is positioned within a portable electronic device 100, such as a cell phone, such that the first layer 20 of the heat spreader 10 is in thermal connection with a heat source 110, such as a chipset. Moreover, the heat spreader 10 is positioned between the heat source 110 and a second component 120, such as the battery of the cell phone or a section of the outer case, thus shielding the second component 120 from heat generated by the heat source 110. Fan 40 creates airflow which is directed by the diffuser 50 across the surface structures 32 of the second layer 30 of the heat spreader 10, thus dissipating heat transferred into the heat spreader 10 from the heat source 110.

Therefore, the use of a heat spreader 10 comprising a first layer 20 which comprises at least one sheet of compressed particles of exfoliated graphite having two major surfaces 20a and 20b; and a second layer 30 which comprises a metal foil having two major surfaces 30a and 30b, one of the major surfaces 30b of the metal foil layer 30 having surface structures 32 thereon, wherein a first major surface 20a of the graphite layer 20 and a second major surface 30a of the metal foil layer 30 are in thermal connection with each other, the surface structures 32 on the major surface 30b of the metal foil layer 30 comprising raised fins which create airflow turbulence, increased heat dissipation surface area, or both, especially when used with a fan 40 and a diffuser 50, can effectively dissipate heat from the heat source(s) 110 in a low profile electronic device 100 in a manner superior to that heretofore seen.

All cited patents, patent applications and publications referred to in this application are incorporated by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A heat spreader comprising:
(a) a first layer which comprises at least one sheet of compressed particles of exfoliated graphite having two major surfaces; and
(b) a second layer which comprises a metal foil having two major surfaces, a first major surface of the metal foil layer having surface structures thereon,
wherein at least about 25% of the surface area of a first major surface of the graphite layer is adhered to, attached to, or in contact with a second major surface of the metal foil layer, the surface structures on the first major surface of the metal foil layer comprising raised structures which have a height no more than about 10 times the thickness of the first layer, and which increase airflow turbulence, increase heat dissipation surface area, or both.

2. The heat spreader of claim 1, wherein the first layer has a thickness of from about 0.05 mm to about 2.0 mm.

3. The heat spreader of claim 1, wherein the first layer has an in-plane thermal conductivity of at least about 150 W/m-K.

4. The heat spreader of claim 1, wherein the second layer has a thickness of from about 0.025 mm to about 1.0 mm.

5. The heat spreader of claim 4, wherein the metal foil comprises aluminum, copper, steel or combinations thereof.

6. An electronic device comprising:
(a) a heat spreader which comprises
(i) a first layer which comprises at least one sheet of compressed particles of exfoliated graphite having two major surfaces; and
(ii) a second layer which comprises a metal foil having two major surfaces, a first major surface of the second layer having surface structures thereon,
wherein at least about 25% of the surface area of a first major surface of the first layer is adhered to, attached to, or in contact with a second major surface of the second layer, the surface structures on the first major surface of the second layer having a height no greater than about 10 times the thickness of the first layer, and which increase airflow turbulence, increase heat dissipation surface area, or both; and
(b) a mechanism which directs air across the surface structures of the second layer of the heat spreader.

7. The electronic device of claim 6, wherein the first layer of the heat spreader has a thickness of from about 0.05 mm to about 2.0 mm.

8. The electronic device of claim 6, wherein the first layer of the heat spreader has an in-plane thermal conductivity of at least about 150 W/m-K.

9. The electronic device of claim 6, wherein the second layer of the heat spreader has a thickness of from about 0.025 mm to about 1.0 mm.

10. The electronic device of claim 9, wherein the metal foil of the heat spreader comprises aluminum, copper, steel or combinations thereof.

11. The electronic device of claim 6, wherein the mechanism which directs air across the surface structures of the second layer of the heat spreader comprises a fan.

12. The electronic device of claim 11, wherein the fan includes a diffuser which directs the flow of air across the heat spreader so as to improve heat dissipation as compared to a fan without the diffuser.

13. The electronic device of claim 6, wherein a second major surface of the first layer of the heat spreader is in thermal connection with a surface of a heat source.

14. The electronic device of claim 13, wherein the surface area of the second major surface of the first layer of the heat spreader is greater than the surface area of that part of the heat source with which second major surface of the first layer of the heat spreader is in thermal connection.

15. The electronic device of claim 6, which comprises a low profile electronic device.

16. A photovoltaic solar panel comprising:
a heat spreader which comprises
(a) a first layer which comprises at least one sheet of compressed particles of exfoliated graphite having two major surfaces; and
(b) a second layer which comprises a metal foil having two major surfaces, a first major surface of the second layer having surface structures thereon,
wherein at least about 25% of the surface area of a first major surface of the first layer is adhered to, attached to, or in contact with a second major surface of the second layer, the surface structures on the first major surface of the second layer having a height no greater than about 10 times the thickness of the first layer, and which increase airflow turbulence, increase heat dissipation surface area, or both.

17. The photovoltaic solar panel of claim 16, which further comprises a mechanism which directs air across the surface structures of the second layer of the heat spreader.

18. The photovoltaic solar panel of claim 16, wherein the first layer of the heat spreader has a thickness of from about 0.05 mm to about 2.0 mm.

19. The photovoltaic solar panel of claim 16, wherein the second layer of the heat spreader has a thickness of from about 0.025 mm to about 1.0 mm.

20. The photovoltaic solar panel of claim 17, wherein the mechanism which directs airflow across the surface structures of the second layer of the heat spreader includes a diffuser which directs the flow of air across the heat spreader so as to improve heat dissipation as compared to without the diffuser.
